(19) United States
(12) Patent Application Publication
(10) Pub. No.: US 2018/0307171 A1
(43) Pub. Date: Oct. 25, 2018

(54) REMAINING PAPER DETERMINATION APPARATUS AND IMAGE FORMING APPARATUS

(71) Applicant: KONICA MINOLTA, INC., Tokyo (JP)

(72) Inventor: Takamitsu SATSUKAWA, Toyokawa-shi (JP)

(73) Assignee: KONICA MINOLTA, INC., Tokyo (JP)

(21) Appl. No.: 15/946,504

(22) Filed: Apr. 5, 2018

(30) Foreign Application Priority Data
Apr. 24, 2017 (JP) 2017-085678

(51) Int. Cl. G03G 15/00

(52) U.S. Cl. CPC G03G 15/553

(57) ABSTRACT

A remaining paper determination apparatus that determines existence/non-existence of remaining paper in a paper conveyance path that conveys paper, includes: a capacitance sensor that detects capacitance of the paper conveyance path; and a remaining paper determination part that determines existence/non-existence of remaining paper on the basis of a detection value of the capacitance sensor, wherein the remaining paper determination part includes a base level setting part that sets a base level on the basis of an output value of the capacitance sensor of when there is no paper in the paper conveyance path, and a threshold setting part that sets a determination threshold by adding a predetermined default value to the base level, and compares the detection value of the capacitance sensor with a latest determination threshold and performs determination according to a magnitude relationship therebetween.

The entire disclosure of Japanese patent Application No. 2017-085678, filed on Apr. 24, 2017, is incorporated herein by reference in its entirety.

### BACKGROUND

### Technological Field

The present invention relates to a remaining paper determination apparatus that determines existence/non-existence of remaining paper in a paper conveyance path that conveys paper. Moreover, an image forming apparatus including a remaining paper determination apparatus is also an object.

### Description of the Related Art

In a device that performs an operation of conveying paper and is, for example, an image forming apparatus, there is a case where conveyance of paper is stopped from any cause. In that case, conveyance is resumed after a cause why the conveyance is stopped is solved. However, there is a case where paper remains in the middle of a conveyance path at a place other than a place where the conveyance stoppage is caused. When conveyance of paper is directly resumed in this case, the conveyance is stopped again. Thus, it is necessary to remove such remaining paper.

Thus, various technologies to detect existence of remaining paper have been proposed in related arts. JP 2007-297192 A is one of these. In a technology of JP 2007-297192 A, a capacitance sensor and a metal target are arranged in such a manner as to face each other with a paper conveyance path therebetween. Then, it is determined by a comparison between an output value of the capacitance sensor and a predetermined threshold value whether there is one sheet of paper. Accordingly, double feeding of paper can be detected. It is considered to use this technology for detection of remaining paper in a conveyance path.

However, there is a following problem in the above-described related art. An output value of a capacitance sensor is determined not only by the number of sheets of overlapped paper in a conveyance path. This is because there are naturally paper powder caused by paper, and other kinds of dust in a conveyance path that conveys paper. This dust also influences capacitance of a conveyance path. Furthermore, an amount of dust in a conveyance path is not constant. Thus, determination of the number of sheets of overlapped paper by the technology of JP 2007-297192 A is not accurate because of existence of dust. Thus, not only detection of double feeding but also determination whether there is paper in a conveyance path is not reliable.

### SUMMARY

The present invention has been made to solve a problem of the above-described technology in the related art. That is, an object of the present invention is to provide a remaining paper determination apparatus that can reliably determine existence/non-existence of remaining paper without being influenced by an accumulation amount of dust in a paper conveyance path, and an image forming apparatus including the remaining paper determination apparatus.

To achieve the abovementioned object, according to an aspect of the present invention, a remaining paper determination apparatus that determines existence/non-existence of remaining paper in a paper conveyance path that conveys paper, reflecting one aspect of the present invention comprises: a capacitance sensor that detects capacitance of the paper conveyance path; and a remaining paper determination part that determines existence/non-existence of remaining paper on the basis of a detection value of the capacitance sensor, wherein the remaining paper determination part includes a base level setting part that sets a base level on the basis of an output value of the capacitance sensor of when there is no paper in the paper conveyance path, and a threshold setting part that sets a determination threshold by adding a predetermined default value to the base level, and compares the detection value of the capacitance sensor with a latest determination threshold and performs determination according to a magnitude relationship therebetween.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a sectional view illustrating a schematic configuration of an image forming apparatus according to an embodiment;

FIG. 2 is a block diagram illustrating a configuration of a control system of the image forming apparatus according to the embodiment;

FIG. 3 is a sectional view illustrating a situation in which a capacitance sensor is arranged;

FIG. 4 is a plan view illustrating the situation in which the capacitance sensor is arranged;

FIG. 5 is a block diagram illustrating a schematic configuration of a detecting circuit of the capacitance sensor;

FIG. 6 is a graph illustrating an example of a change in an output value of capacitance detection before, during, and after passing of a sheet;

FIG. 7 is a graph for describing a setting of a determination threshold for remaining paper;

FIG. 8 is a graph for describing a setting of a determination threshold of a case where an optical sensor is used (comparative example);

FIG. 9 is a graph illustrating a relationship between a difference in a sensor output according to existence/non-existence of a sheet, and a basis weight of the sheet;

FIG. 10 is a graph illustrating a setting of a determination threshold according to a default value set with respect to a sheet having a minimum basis weight; and

FIG. 11 is a flowchart illustrating a processing procedure of setting a determination threshold and determining remaining paper.

### DETAILED DESCRIPTION OF EMBODIMENTS

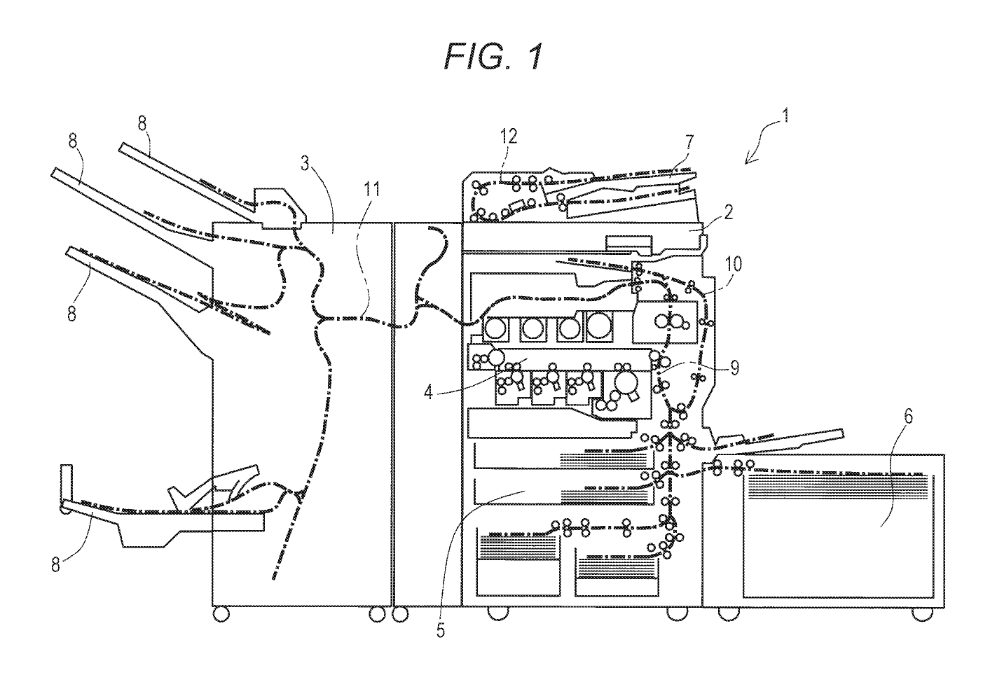

Hereinafter, one or more embodiments of the present invention will be described in detail with reference to the drawings. However, the scope of the invention is not limited to the disclosed embodiments. The present embodiment is an image forming apparatus 1 which is illustrated in FIG. 1 and to which the present invention is applied. The image forming apparatus 1 in FIG. 1 includes a main body part 2 and a finisher 3. The main body part 2 is a part that performs image forming onto printing paper. The finisher 3 is a part that performs post processing on the printing paper on which image forming is performed in the main body part 2.

The main body part 2 will be described briefly. The main body part 2 has an image forming part 4 built-in. The image forming part 4 is a part that forms a toner image and makes printing paper carry the toner image. A paper feeding part 5 is provided in a part on a lower side of the image forming part 4 in the main body part 2. Furthermore, an external large-capacity cassette 6 is attached to a side of the paper feeding part 5 in the main body part 2. Each of the paper feeding part 5 and the external large-capacity cassette 6 stores printing paper supplied to the image forming part 4. Furthermore, a scanner 7 is arranged in a part on an upper side of the image forming part 4 in the main body part 2. The scanner 7 is a part that reads an image on a document and acquires image data for image forming in the image forming part 4.

The finisher 3 will be described briefly. As post processing functions in the finisher 3, there are various kinds such as stacking, sorting, paper folding, stapling, and punching. Various devices that perform these functions are arranged throughout the finisher 3. Then, a plurality of paper output trays 8 is provided on an outer surface of the finisher 3.

As described above, a paper feeding conveyance path 9, a reverse conveyance path 10, and a paper ejection conveyance path 11 each of which conveys printing paper are provided in the image forming apparatus 1 including the main body part 2 and the finisher 3. The paper feeding conveyance path 9 is a path that conveys printing paper supplied from the paper feeding part 5 or the external large-capacity cassette 6 to the image forming part 4. The reverse conveyance path 10 is a path that reverses printing paper and conveys this from a downstream side to an upstream side of the image forming part 4 in a case of duplex printing. The paper ejection conveyance path 11 is a path that conveys printing paper, on which an image is already formed, from the image forming part 4 to the paper output trays 8 of the finisher 3. The above-described various post processing functions are performed during conveyance in the paper ejection conveyance path 11. Moreover, a document conveyance path 12 that conveys a document is provided in the scanner 7.

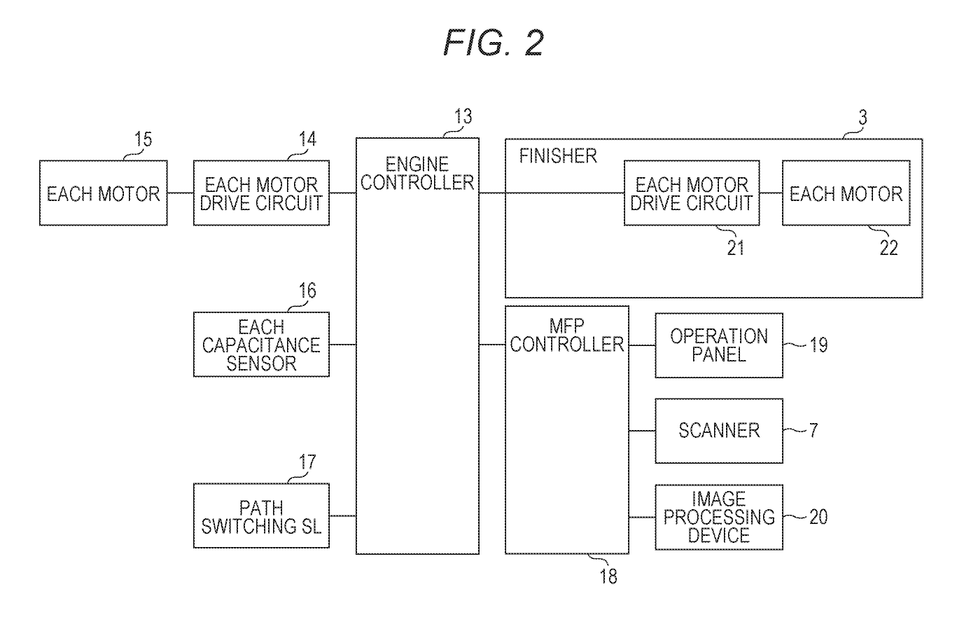

A configuration of a control system of the image forming apparatus 1 is illustrated in the block diagram in FIG. 2. An engine controller 13 is a main configuration of the control system in FIG. 2. The engine controller 13 is a control part that controls mechanical driving or power supplying of each part of the main body part 2 of the image forming apparatus 1. Determination of remaining paper (described later) is also performed in the engine controller 13.

Each motor 15 is connected to the engine controller 13 via each motor drive circuit 14. Each motor 15 is a drive source to drive rollers of each part in the main body part 2. Each capacitance sensor 16 and a path switching solenoid 17 are further connected to the engine controller 13. Capacitance sensors 16 are arranged throughout the paper feeding conveyance path 9, the reverse conveyance path 10, the paper ejection conveyance path 11, and the document conveyance path 12 and are sensors that detect whether printing paper or a document is accumulated. The path switching solenoid 17 is a switching device that switches to which of the reverse conveyance path 10 and the paper ejection conveyance path 11 printing paper after the image forming is advanced.

The engine controller 13 is also connected to an MFP controller 18. The MFP controller 18 is a control part that handles image data related to image forming, and other kinds of data. An operation panel 19, a scanner 7, and an image processing device 20 are connected to the MFP controller 18. The image processing device 20 performs storing, color space conversion, correction processing, and the like with respect to image data.

Each motor 22 is further connected to the engine controller 13 via each motor drive circuit 21. Each motor drive circuit 21 and each motor 22 are provided in the finisher 3. That is, each motor 22 is a drive source to drive rollers of each part in the finisher 3.

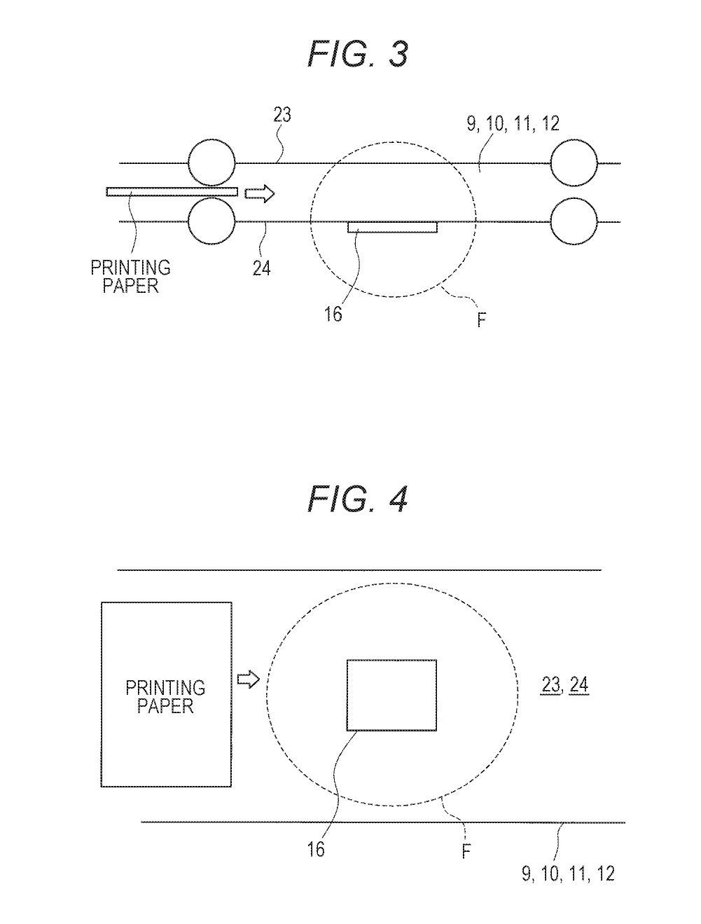

Next, a capacitance sensor 16 will be described. As illustrated in a sectional view in FIG. 3, the capacitance sensor 16 is a metallic plate attached to one of guide plates 23 and 24 that separate both surfaces of the paper feeding conveyance path 9, the reverse conveyance path 10, the paper ejection conveyance path 11, or the document conveyance path 12. When this is seen in a plan view in FIG. 4, the capacitance sensor 16 is placed around the center of a full width of the conveyance path (9, 10, 11, or 12). Note that in FIG. 3, a facing metallic plate such as what is indicated by “14” in FIG. 1 in JP 2007-297192 A may be arranged on the other one of the guide plates 23 and 24.

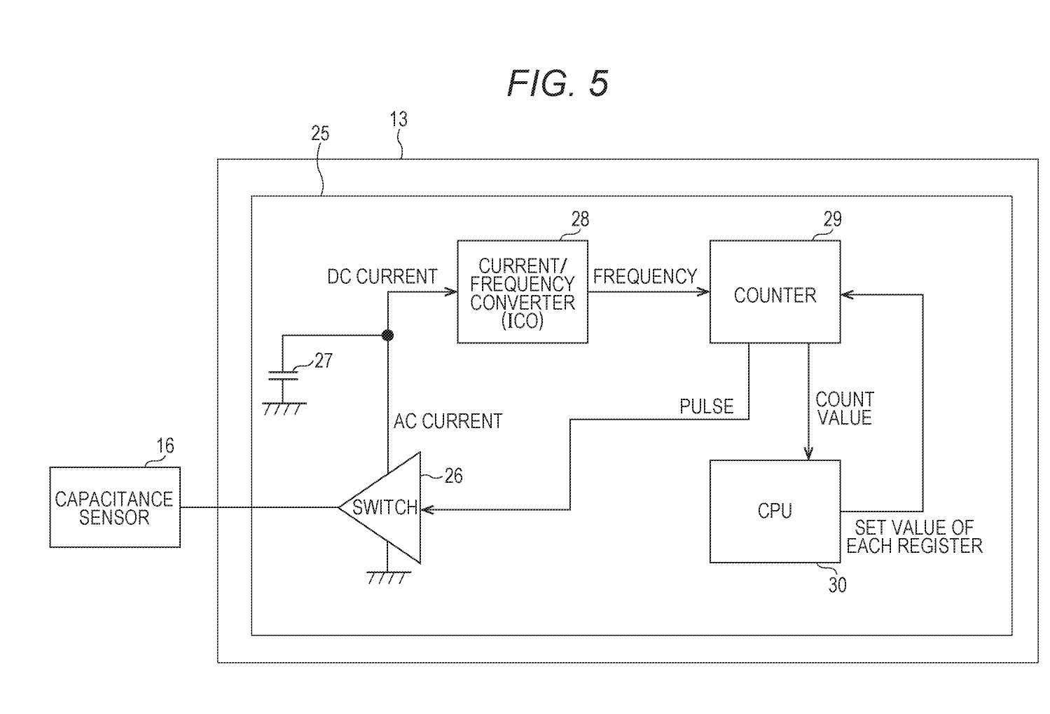

As illustrated in FIG. 5, a detecting circuit 25 for detection of remaining paper by the capacitance sensor 16 is provided in the engine controller 13. A switch 26, a capacitor 27, a current/frequency converter 28, a counter 29, and a CPU 30 are provided in the detecting circuit 25. The switch 26 is controlled by a pulse signal emitted from the counter 29. The capacitor 27 is included in a low-pass filter, and inputs, into the current/frequency converter 28, a low-frequency component including a direct current in a current flowing in the switch 26. The current/frequency converter 28 outputs a frequency signal corresponding to an input current value. This frequency signal is counted by the counter 29, and a variation of the count value is monitored by the CPU 30. Furthermore, a set value of each register in the counter 29 is managed by the CPU 30.

Here, trackability of potential of the capacitance sensor 16 of when on/off of the switch 26 is switched depends on capacitance of the capacitance sensor 16. More specifically, this depends on a permittivity of a substance in a region F indicated by a broken line in each of FIG. 3 and FIG. 4. Thus, capacitance of the capacitance sensor 16 varies greatly depending on whether there is printing paper in the region F. Thus, a count value of the counter 29 becomes an index signal of existence/non-existence of printing paper in the conveyance path (9, 10, 11, or 12).

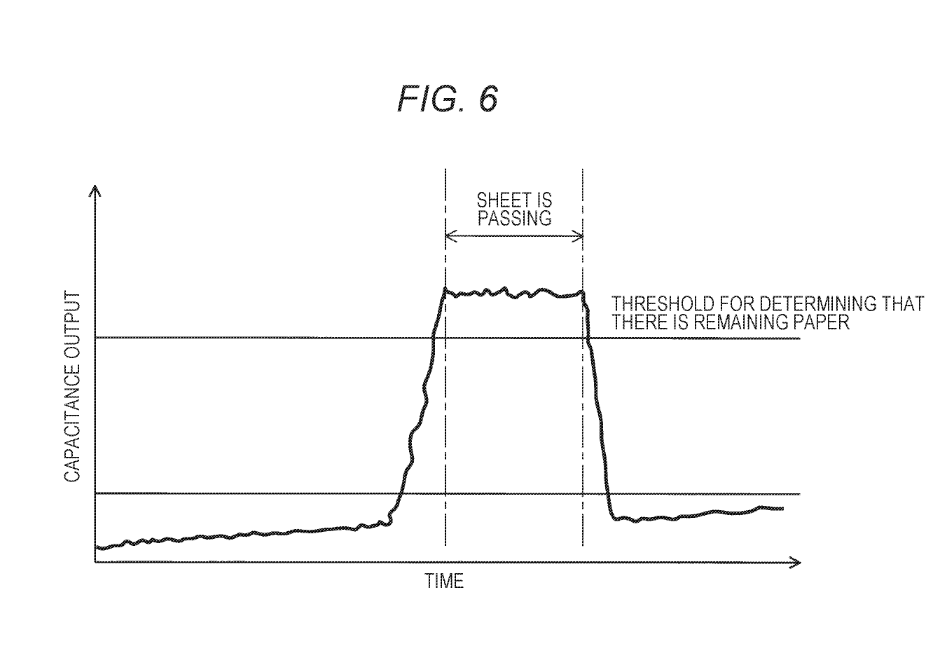

However, the capacitance of the capacitance sensor 16 depends not only on existence/non-existence of printing paper. There is a possibility that dust described in a paragraph of “Description of the Related art” is also in the conveyance path (9, 10, 11, or 12), and the capacitance of the capacitance sensor 16 also depends on an amount thereof. For example, an example of a temporal change of an output value of the capacitance sensor 16 of when a sheet passes through the conveyance path (9, 10, 11, or 12) is illustrated in FIG. 6. In FIG. 6, an output value becomes significantly high during passing of a sheet compared to the value before and after that. This is obviously an effect caused by existence of a sheet in the region F. However, an output value in a period before and after the passing of a sheet is not constant and is increased little by little in FIG. 6. It can be said that this indicates that an amount of existing dust in the region F is gradually increasing during measurement in FIG. 6.

Nonetheless, an increase in an output value in a degree of FIG. 6 due to existence of dust is minor compared to an increase in an output value due to existence of a sheet. Thus, only from FIG. 6, it may be considered that determination of existence of remaining paper can be sufficiently performed when a determination threshold is set to be a little lower than an output value level of during passing of a sheet. However, there is a case where an amount of existing dust in the conveyance path (9, 10, 11, or 12) becomes much higher. There is a possibility that an output value reaches a level of the determination threshold in FIG. 6 only by an influence of the dust. In that case, it is determined that there is remaining paper although there is none.

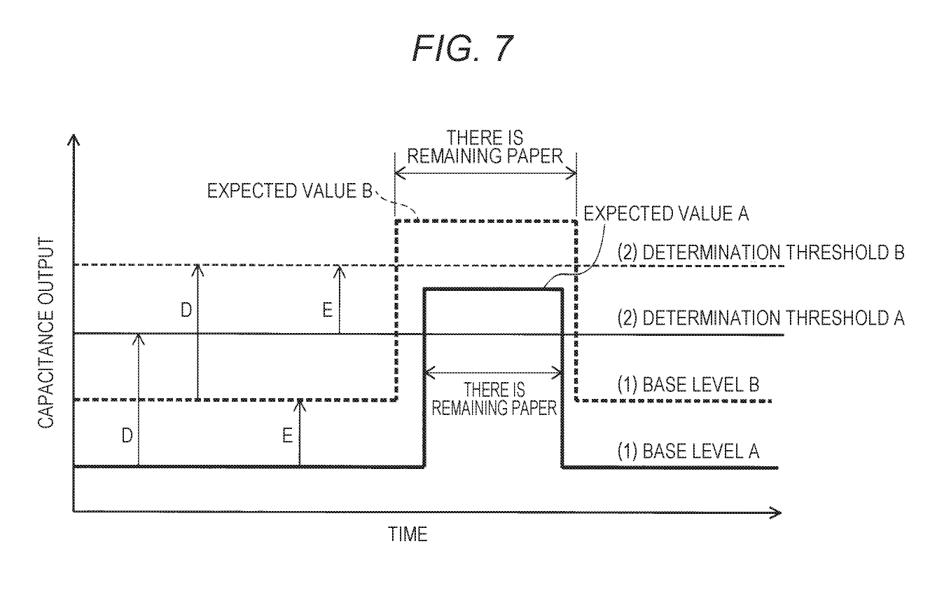

Thus, in the image forming apparatus 1 of the present embodiment, an actual determination threshold is set in a manner illustrated in FIG. 7. First, a base level is set on the basis of an output value of the capacitance sensor 16 of when there is no sheet in the conveyance path (9, 10, 11, or 12) ((1) in FIG. 7). The base level reflects an amount of dust existing in the conveyance path (9, 10, 11, or 12) at the time point. Base levels of two standards that are a base level A of a case where an amount of dust is relatively low and a base level B of a case where an amount of dust is relatively high are illustrated in FIG. 7.

Note that as it can be understood from FIG. 6, an actual output value of the capacitance sensor 16 tends to fluctuate for a certain degree over time. Thus, it is preferable to set a base level by averaging an output value of the capacitance sensor 16 in a certain period instead of directly setting an output value of the capacitance sensor 16 at a certain time point as a base level. Moreover, it is preferable that an output value of the capacitance sensor 16 is constantly monitored and a base level is updated at an arbitrary frequency. This is because an amount of dust in the conveyance path (9, 10, 11, or 12) varies constantly.

Then, a determination threshold is set on the basis of the set base level ((2) in FIG. 7). Setting of the determination threshold is performed by addition of a default value D to the currently-set base level. The default value D is a value that is not influenced by an amount of dust. Thus, a low determination threshold A is set for a low base level A, and a high determination threshold B is set for a high base level B. In a case where a base level is updated at an arbitrary frequency, a determination threshold is also updated at the arbitrary frequency. Thus, in a case where a base level varies from A to B (E), a determination threshold also varies from A to B (E).

The default value D is set to be a little lower than a difference in an output value of the capacitance sensor 16 which difference is generated by existence/non-existence of a sheet in the conveyance path (9, 10, 11, or 12). Thus, output values (expected value A and expected value B) of the capacitance sensor 16 of a case where there is a sheet in the conveyance path (9, 10, 11, or 12) become values that are a little higher than the set determination threshold A and determination threshold B in both of a situation of (A) and a situation of (B) in FIG. 7.

Thus, in a case where an operation is stopped from any cause during operation of the image forming apparatus 1, it is possible to determine, from an output value of the capacitance sensor 16 in the stopped state, whether there is a remaining sheet in a region F with respect to the capacitance sensor 16. That is, it is determined that there is remaining paper when the output value is higher than a determination threshold set at that time point. It is determined that there is no remaining paper when the output value is lower than the determination threshold at that time. This determination is not influenced by an amount of dust. This is because the determination threshold is set as a value corresponding to the amount of dust in a manner described above. Note that in FIG. 7, a period in which “there is remaining paper” varies between A and B. However, this is to separate graphs, and there is no other meaning.

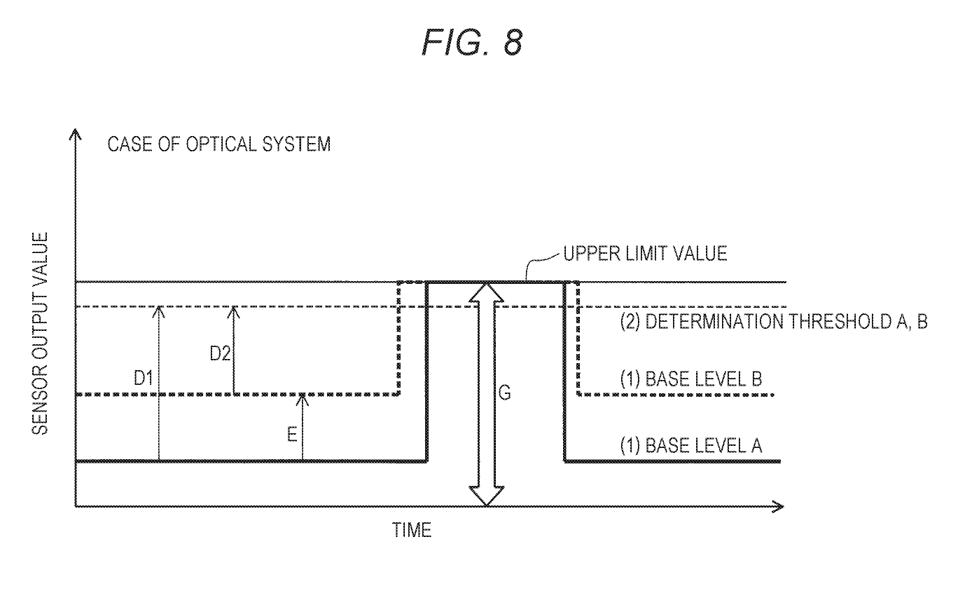

Since there is high additivity of an output value of the capacitance sensor 16, determination that is not influenced by the amount of dust can be performed in the present embodiment. When an optical sensor is used instead of the capacitance sensor 16, this is not possible. This will be described with reference to FIG. 8. In FIG. 8, an output value in various situations in a case where a reflective-type optical sensor is used is illustrated. A base level A and a base level B in FIG. 8 do not vary greatly from those with the same names in FIG. 7. These are sensor output values based on dust of a case where an amount of dust is low and a case where the amount is high.

However, a sensor output value of a case where there is remaining paper is constant at an upper limit value regardless of the amount of dust. An output value of a case where light is reflected on a whole surface of remaining paper is the upper limit, and there is no output value higher than this. A range of the sensor output value is indicated by “G” in FIG. 8. That is, additivity of the output value of the optical sensor is low. Thus, a determination threshold A and a determination threshold B respectively corresponding to a base level A and a base level B become the same. That is, differences D1 and D2 between a base level and a determination threshold are not constant in FIG. 8 although a default value D is constant in FIG. 7. In other words, even when there is a variation E in a base level, the variation E is not reflected on a determination threshold.

Thus, a difference between a base level and a determination threshold is decreased as an amount of dust is increased, and a possibility of erroneous determination is increased. When a base level becomes very close to a determination threshold, determination is nearly impossible. Note that even in a case where a transmission-type optical sensor is used, a condition is the same although an upper side and a lower side of a vertical axis in FIG. 8 are reversed. On the other hand, in the present embodiment, determination that is not influenced by an amount of dust can be performed since the capacitance sensor 16 in which additivity of an output value is high is used.

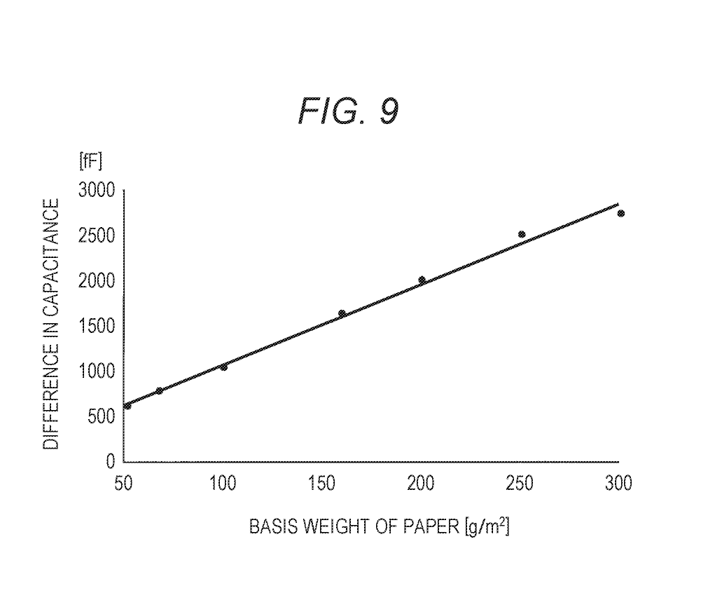

Here, a value to be set as a default value “D” in FIG. 7 will be described. From what has been described above, the default value D is a value that is a little lower than a difference in an output value of the capacitance sensor 16 which difference is generated by existence/non-existence of a sheet. This difference in a sensor output due to existence/non-existence of a sheet is related to a basis weight (weight in unit area) of the sheet. As illustrated in FIG. 9, the difference becomes larger as the basis weight becomes higher. Thus, the default value D is made to be low in a case where the basis weight of a sheet is low, and the default value D is made to be high in a case where the basis weight is high.

In actually, the default value D is set with reference to paper that is expected to pass through a place of the capacitance sensor 16 in the image forming apparatus 1 and that has the lowest basis weight. This is because detection can be performed not only in a case where paper having the lowest basis weight is remaining paper but also in a case where paper having a basis weight higher than that is remaining paper when the default value D set in such a manner is used.

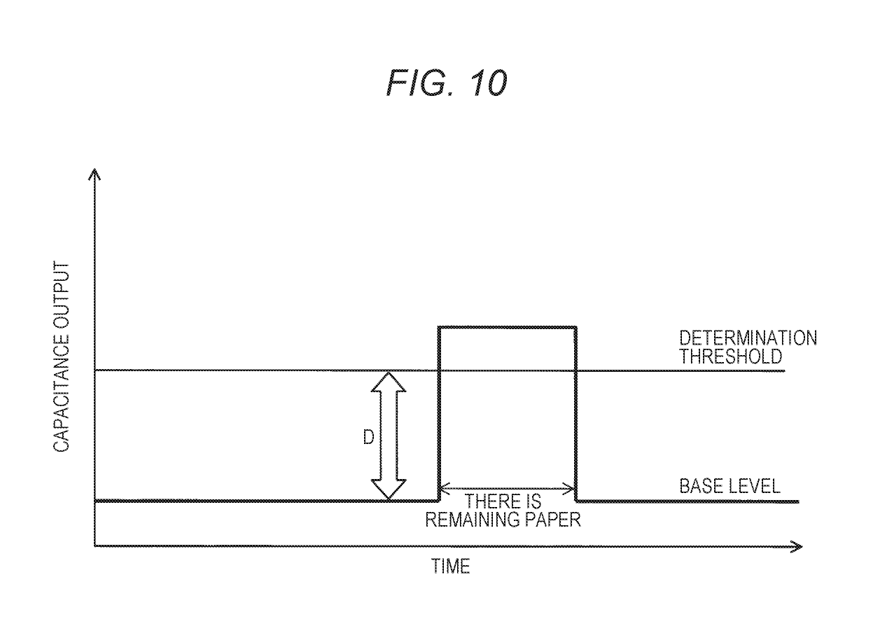

More specifically, the graph in FIG. 9 is previously stored in the engine controller 13. Furthermore, the lowest basis weight expected for passing paper is usually stored, as specification data of the image forming apparatus 1, in the engine controller 13. With this arrangement, the default value D, that is, capacitance of paper expected to have the lowest basis weight can be read from FIG. 9. Alternatively, a default value D may be set by multiplication of the capacitance, which is read in such a manner, by a predetermined safety factor (such as around 30 to 95%). Furthermore, the graph in FIG. 9 may be previously stored in a form of being multiplied by a safety factor. A default value D in FIG. 10 may be set in such a manner. Alternatively, the default value D calculated in the above manner may be stored in the engine controller 13.

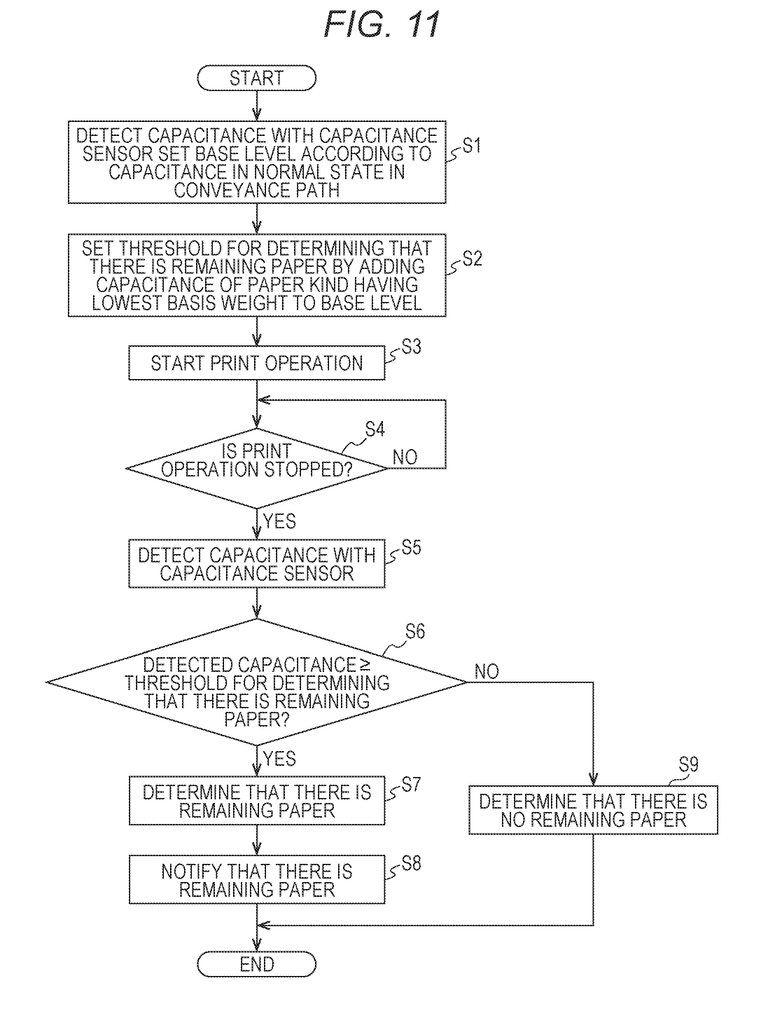

Next, a processing procedure of remaining paper determination will be described. This procedure illustrated in FIG. 11 includes processing related to setting of a determination threshold, and a part related to determination of existence/non-existence of remaining paper. In this flow, S1 (setting of base level) and S2 (setting of determination threshold) are performed before a start of a print operation in S3. As described above, a setting of a base level in S1 is a value that is an output value of the capacitance sensor 16 of when no sheet is passing in the conveyance path (9, 10, 11, or 12), the output value being averaged in a predetermined period. Setting of a determination threshold in S2 is performed by addition of a default value D to a base level.

S1 and S2 described above are constantly performed when the power of the image forming apparatus 1 is on and a print operation is not started yet. Accordingly, a determination threshold is set dynamically according to a variation of an accumulation amount of dust in the conveyance path (9, 10, 11, or 12). This also means that an output value of the capacitance sensor 16 for setting of a base level is acquired while an image forming operation is not performed. Accordingly, a base level and a determination threshold are set according to a sensor output value with as little noise component as possible. Thus, accuracy of a set determination threshold is high. An output value of the capacitance sensor 16 is likely to be influenced by an operation of a surrounding electric circuit. Thus, a noise is likely to be included in the output value of the capacitance sensor 16 during an image forming operation. In order to accurately set a determination threshold, a sensor output value of not during the image forming operation is preferably used.

When a print operation is started (S3), it is monitored whether the print operation is stopped in the middle (S4). The print operation is stopped in the middle, for example, by a cause such as generation of a paper jam. When the print operation is stopped (S4: Yes), an output value of capacitance of the capacitance sensor 16 is acquired (S5). Then, the acquired capacitance is compared with the latest determination threshold set in S2 (S6). In a case where the acquired capacitance is lower than the determination threshold (S6: No), it is determined that there is no remaining paper (S9).

On the other hand, in a case where the acquired capacitance is higher than the determination threshold (S6: Yes), it is determined that there is remaining paper (S7). Here, there being remaining paper means that remaining paper is at a position, where the capacitance sensor 16 is provided, in the conveyance path (9, 10, 11, or 12). Thus, in a case where the capacitance sensor 16 is provided in each of a plurality of places in the image forming apparatus 1, a determination result may vary depending on the capacitance sensor 16. Furthermore, the remaining paper that is a cause of determination that there is remaining paper is not necessarily the jammed paper that causes the print operation to stop. Then, with the operation panel 19 in FIG. 2, a user is notified of existence of remaining paper and a position thereof (S8). Accordingly, the user can appropriately perform operation of removing the remaining paper. This is the description of the flow in FIG. 11.

As described above in detail, according to the image forming apparatus 1 of the present embodiment, the capacitance sensor 16 is provided in the conveyance path (9, 10, 11, or 12) of a sheet in the apparatus. With this arrangement, capacitance of the conveyance path (9, 10, 11, or 12) is detected. An influence of existence/non-existence of remaining paper and an influence of an amount of dust in the conveyance path (9, 10, 11, or 12) are added to and reflected on the capacitance. Then, a base level is set according to an output value of the capacitance sensor 16 of when there is no sheet in the conveyance path (9, 10, 11, or 12) before a start of image forming. Moreover, a determination threshold is set by addition of a default value D to this base level which value is set on the basis of capacitance of paper having the lowest basis weight. In such a manner, the image forming apparatus 1 that can determine existence/non-existence of remaining paper in the conveyance path (9, 10, 11, or 12) without being influenced by an amount of dust is realized.

Although embodiments of the present invention have been described and illustrated in detail, the disclosed embodiments are made for purposes of illustration and example only and not limitation. The scope of the present invention should be interpreted by terms of the appended claims. Thus, it is obvious that the present invention can be improved or modified within the spirit and scope thereof. For example, in the present embodiment, the image forming apparatus 1 including the scanner 7 and the finisher 3 is an object, and the capacitance sensor 16 can be provided anywhere in the paper feeding conveyance path 9, the reverse conveyance path 10, the paper ejection conveyance path 11, and the document conveyance path 12. However, this is not the limitation. The present invention can be applied to what only includes a main body part 2, an apparatus only including a scanner 7, and an apparatus only including a finisher 3. Furthermore, in a main body part 2, a configuration of an image forming part 4 may be a system other than a toner system.

What is claimed is:

1. A remaining paper determination apparatus that determines existence/non-existence of remaining paper in a paper conveyance path that conveys paper, the apparatus comprising:
a capacitance sensor that detects capacitance of the paper conveyance path; and
a remaining paper determination part that determines existence/non-existence of remaining paper on the basis of a detection value of the capacitance sensor,
wherein the remaining paper determination part
includes a base level setting part that sets a base level on the basis of an output value of the capacitance sensor of when there is no paper in the paper conveyance path, and a threshold setting part that sets a determination threshold by adding a predetermined default value to the base level, and
compares the detection value of the capacitance sensor with a latest determination threshold and performs determination according to a magnitude relationship therebetween.

2. The remaining paper determination apparatus according to claim 1, wherein the default value in the remaining paper determination part is set with reference to paper that is expected to pass through the paper conveyance path and that is of a kind having a lowest basis weight.

3. The remaining paper determination apparatus according to claim 1, wherein the remaining paper determination part compares a detection value of the capacitance sensor of when conveyance of paper in the paper conveyance path is stopped with the latest determination threshold.

4. The remaining paper determination apparatus according to claim 1, wherein the capacitance sensor is arranged on a guide plate at least on one surface side of the paper conveyance path.

5. An image forming apparatus comprising:
an image forming part that forms an image on paper; and
a paper conveyance path that conveys paper for image forming in the image forming part,
wherein the remaining paper determination apparatus according to claim 1 is included in the paper conveyance path.

6. The image forming apparatus according to claim 5, wherein the remaining paper determination part sets the base level while an image forming operation is not performed.
